(19) United States
(12) Patent Application Publication
(10) Pub. No.: US 2017/0091623 A1
(43) Pub. Date: Mar. 30, 2017

(54) COMPUTER READABLE RECORDING MEDIUM, SPECIFYING METHOD, SPECIFYING APPARATUS, AND METHOD OF ANALYZING PROVIDED INFORMATION

(71) Applicant: FUJITSU LIMITED, Kawasaki-shi (JP)

(72) Inventors: Yoshiharu Kato, Suginami (JP); Masafumi Yano, Kawasaki (JP)

(21) Appl. No.: 15/250,008

(22) Filed: Aug. 29, 2016

(30) Foreign Application Priority Data
Sep. 30, 2015 (JP) 2015-195276

(51) Int. Cl. G06N 5/02

(52) U.S. Cl. CPC G06N 5/022

(57) ABSTRACT

A creativity support server extracts a node that is generated by a user from a tree diagram that is generated according to nodes each representing an opinion created by each user to derive a solution to a problem dealt with in a discussion and links each representing relevance between the nodes. The creativity support server classifies the extracted node according to dependency between the extracted node and other nodes included in the tree diagram. The creativity support server specifies a character of the user according to result of the classifying.

### CROSS-REFERENCE TO RELATED APPLICATION

This application is based upon and claims the benefit of priority of the prior Japanese Patent Application No. 2015-195276, filed on Sep. 30, 2015, the entire contents of which are incorporated herein by reference.

### FIELD

The embodiments discussed herein are related to a computer-readable recording medium, a specifying method, a specifying apparatus, and a method of analyzing provided information.

### BACKGROUND

In varying modern society, products and services that create new values and contribute to the society are demanded and therefore creativity support systems that support human creativity and ideas are used. As a creativity support system, for example, the KJ method is known in which relevant sets of information from accumulated information are grouped. In recent years, as a technology that supports the KJ method, a technology is known in which multiple participants input opinions, islands equal in number to the number of groups created from the input opinions are created, and automated documentation based on the links among the islands is carried out.

Non-Patent Document 1: “Hassou Shien Guruupuwea Gungen no Kouka—Suuhyaku no Shikenkekka yori Etamono”, Retrieved Sep. 18, 2015, from https://www.jstage.jst.go.jp/article/tjsai/19/2/19_2_105/_article/-char/ja/

The above-described technology however remains in partial creativity support, does not reach whole creativity support, and is insufficient with respect to creativity support to individuals. For example, ideas are on a subconscious level and therefore continuous support in addition to support in discussions where ideas are given leads to creativeness support to individuals; however, supporting creativity in only discussions as in the above-described technology is far from being sufficient support.

### SUMMARY

According to an aspect of an embodiment, a non-transitory computer-readable recording medium stores therein a program that causes a computer to execute a process. The process includes extracting a node that is generated by a user from a tree diagram that is generated according to nodes each representing an opinion created by each user to derive a solution to a problem dealt with in a discussion and links each representing relevance between the nodes; classifying the extracted node according to dependency between the extracted node and other nodes included in the tree diagram; and specifying a character of the user according to result of the classifying.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram representing an exemplary overall configuration of a system according to a first embodiment;

FIG. 2 is a diagram illustrating exemplary use of the system according to the first embodiment;

FIG. 3 is a diagram illustrating an exemplary functional configuration of a creativity support server;

FIG. 4 is a diagram representing exemplary information that is stored in a node-link information DB;

FIG. 5 is a diagram representing exemplary information that is stored in a tree diagram DB;

FIG. 6 is a table representing exemplary information that is stored in a contribution degree DB;

FIG. 7 is a table representing exemplary information that is stored in a behavior DB;

FIG. 8 is a table representing exemplary information that is stored in a character DB;

FIG. 9 is a diagram illustrating the details of a proposal node;

FIG. 10 is a diagram illustrating the details of an evaluation node;

FIG. 11 is a diagram illustrating exemplary calculation of the degree of contribution of proposal;

FIG. 12 is a diagram illustrating exemplary calculation of the degree of contribution according to evaluation;

FIG. 13 is a diagram illustrating a system for evaluation;

FIG. 14 is a table illustrating the evaluation of each node;

FIG. 15 is a diagram illustrating an exemplary de-silence node;

FIG. 16 is a diagram illustrating an exemplary orientation node;

FIG. 17 is a table illustrating exemplary recognition support items;

FIG. 18 is a graph illustrating exemplary support implemented by visualization of classification of nodes;

FIG. 19 is a graph illustrating exemplary support implemented by visualization of the number of statements of nodes;

FIG. 20 is a flowchart representing a flow of an overall process;

FIG. 21 is a flowchart representing a flow of a contribution degree tallying process;

FIG. 22 is a flowchart representing a flow of a recognition support process; and

FIG. 23 is a diagram of an exemplary hardware configuration.

### DESCRIPTION OF EMBODIMENTS

Preferred embodiments will be explained with reference to accompanying drawings. The following embodiments are not construed as limiting the invention.

### [a] First Embodiment

### Overall Configuration

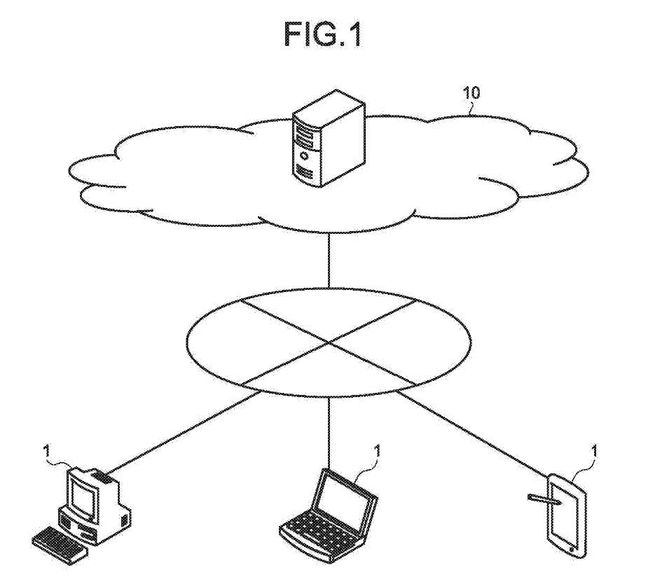

FIG. 1 is a diagram representing an exemplary overall configuration of a system according to a first embodiment. As represented in FIG. 1, the system is a creativity support system allowing multiple users to exchange opinions on various problems to derive solutions and the system includes multiple user terminals 1 and a creativity support server 10.

The embodiment will be described by exemplifying a case where the creativity support server 10 is in a cloud system and each user terminal 1 accesses the creativity support server 10 via a network, such as the Internet, to user the system; however, embodiments are not limited to this. For example, multiple user terminals 1 and the creativity support server 10 may be connected via a local area network (LAN), i.e., it is possible to change the system to any mode.

Each user terminal 1 is a terminal used by each user. Each user terminal 1 is, for example, a personal computer, a mobile phone, or a smartphone. Each user terminal 1 accesses the creativity support server 10 to have discussions to derive solutions in a group. The creativity support server 10 provides a site for discussion to the group including the multiple user terminals 1 and converts the opinion created by each user, etc., into nodes to implement visualization of the discussion.

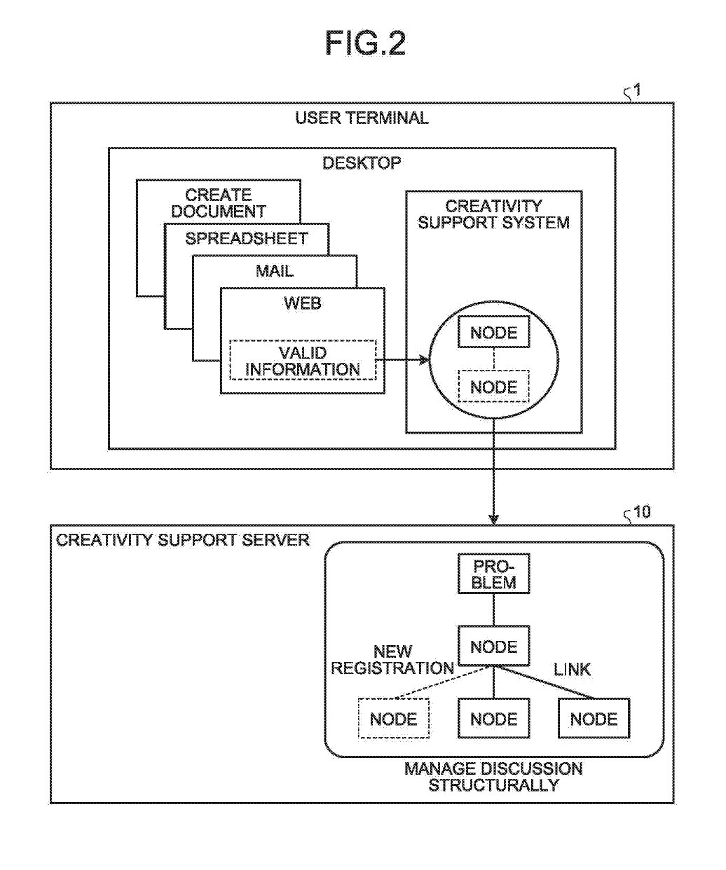

Visualization of discussion will be described with FIG. 2. FIG. 2 is a diagram illustrating exemplary use of the system according to the first embodiment. As illustrated in FIG. 2, the user terminal 1 logs in the creativity support system and displays an input screen of the creativity support system on a desktop. The user belongs to a project and is dealing with general tasks to carry out various activities related to the tasks, such as browsing mails, responding to the mails, and searching for information on the web.

While browsing the webs, when the user terminal 1 retrieves useful information with respect to a problem discussed by the group to which the user terminal 1 belongs, the user terminal 1 records the information and the problem in association with each other. For example, as illustrated in FIG. 2, the user terminal 1 records the information browsed on the web as an opinion or a proposal in a “node”. On recording, in order to associate the information with the problem or previously-recorded information, the user terminal 1 connects the path with a “link”. The members of the project sequentially acquire information and constitute a tree diagram (structure). In the following descriptions, nodes may be simply illustrated with timestamps and user names. For example, the node with Timestamp 5 may be described as Node 5 or the node generated by User A may be described as Node A.

The creativity support server 10 analyzes the information thus input and automatically provides information supporting creativity and encouragement to the members of the project. Furthermore, the creativity support server 10 represents the problem and the degrees of contribution of individuals to the project according to an information analysis command from a project member.

Functional Configuration

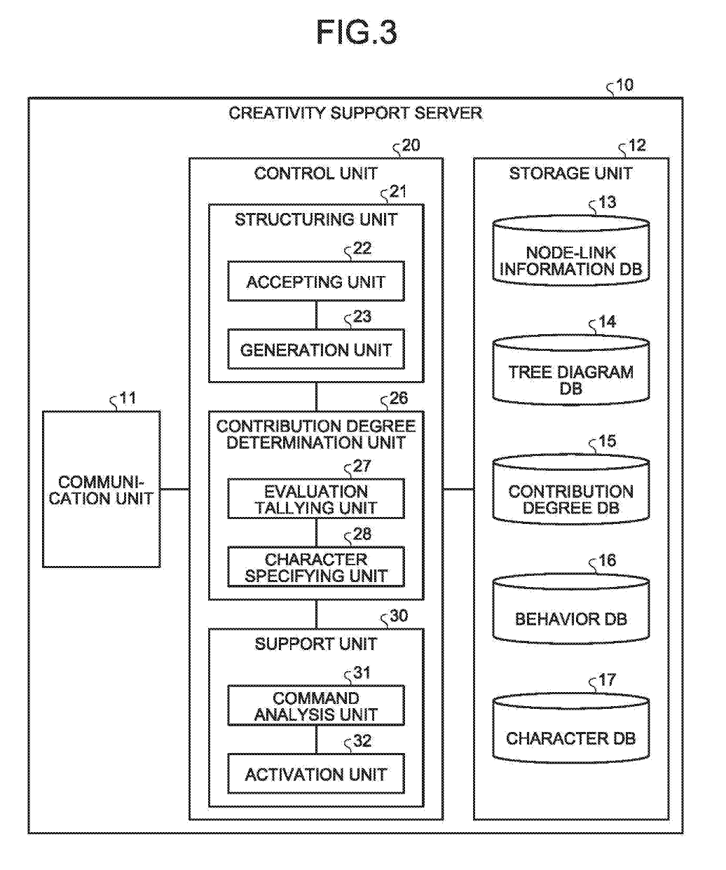

FIG. 3 is a diagram illustrating an exemplary functional configuration of the creativity support server 10. As illustrated in FIG. 3, the creativity support server 10 includes a communication unit 11, a storage unit 12, and a control unit 20.

The communication unit 11 is a processing unit that controls communications with each user terminal 1 regardless whether communications are wired or wireless. For example, the communication unit 11 receives inputs of node or link, which will be described below, and transmits various messages, etc., to support creativity to each user terminal 1.

The storage unit 12 is a storage device that stores data to be used to execute programs and various processes that are executed by the control unit 20. The storage unit 12 is, for example, a hard disk or a memory. The storage unit 12 includes a node-link information DB 13, a tree diagram DB 14, a contribution degree DB 15, a behavior DB 16, and a character DB 17.

The node-link information DB 13 is a database that stores information on nodes and links that constitute a tree diagram. Specifically, the node-link information DB 13 stores scores representing the degrees of contribution to the users who input the nodes and links that can be input to the tree diagram in association with the nodes and links.

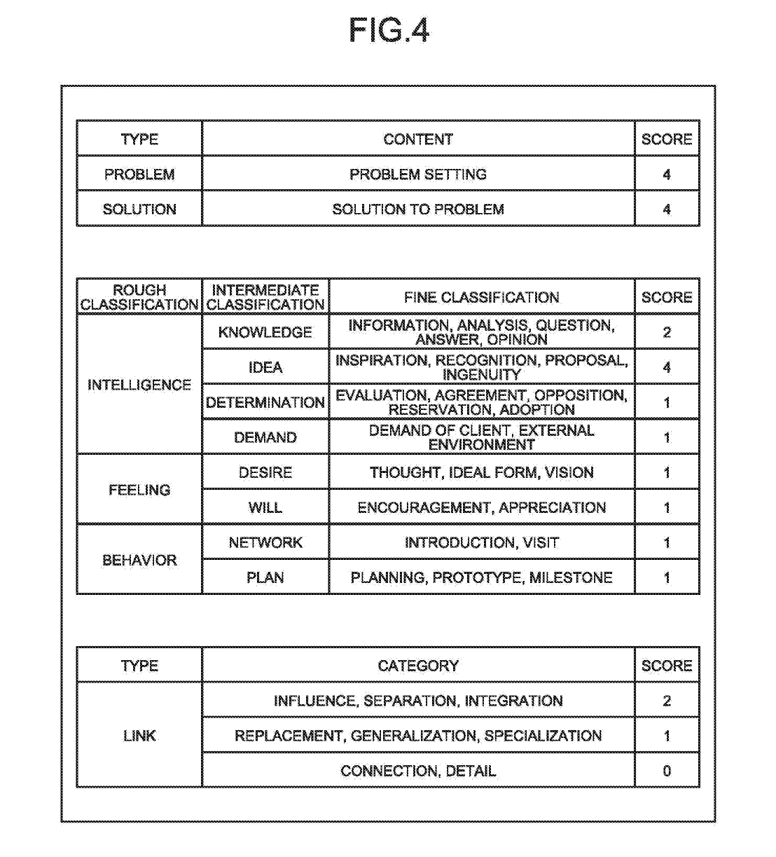

FIG. 4 is a diagram of exemplary information that is stored in the node-link information DB 13. As represented in FIG. 4, the node-link information DB 13 stores “type, content, and score” in association with one another. The “type” stored herein represents the types of nodes that are created and generated by the users, the “content” represents the content, such as the creation or idea specified by the nodes, and the “score” represents the degrees of contribution of the users who creates and generates the nodes. The case represented in FIG. 4 represents that a score of “four points” is assigned to the user who generates a node of “problem” that sets a problem to be discussed and a score of “four points” is assigned to the user who generates a node of “solution” with respect to the problem.

As represented in FIG. 4, the node-link information DB 13 stores “rough classification, intermediate classification, fine classification, and score” in association with one another. The “rough classification, intermediate classification, and fine classification” stored herein represent classification of nodes that are created and generated and “score” represents the degree of contribution of the user who creates and generates the node. FIG. 4 represents the case where the score of “four points” is assigned to the user who generates a node corresponding to the rough classification of “intelligence”, the intermediate classification of “idea”, and the fine classification of “proposal”. FIG. 4 also represents that the score of “one point” is assigned to the user who generates a node corresponding to the rough classification of “intelligence”, the intermediate classification of “determination”, and the fine classification of “evaluation”.

As represented in FIG. 4, the node-link information DB 13 stores “type, classification and score” in association with one another. The “type” stored herein represents the types of links that relate nodes, the “classification” represents the contents of the links, and the “score” represents the degrees of contribution of the users who generates the links. The case according to FIG. 4 represents that the score of “two points” is assigned to a user who connects nodes with the link of “influence” and the score of “one point” is assigned to a user who connects nodes with the link of “specification”.

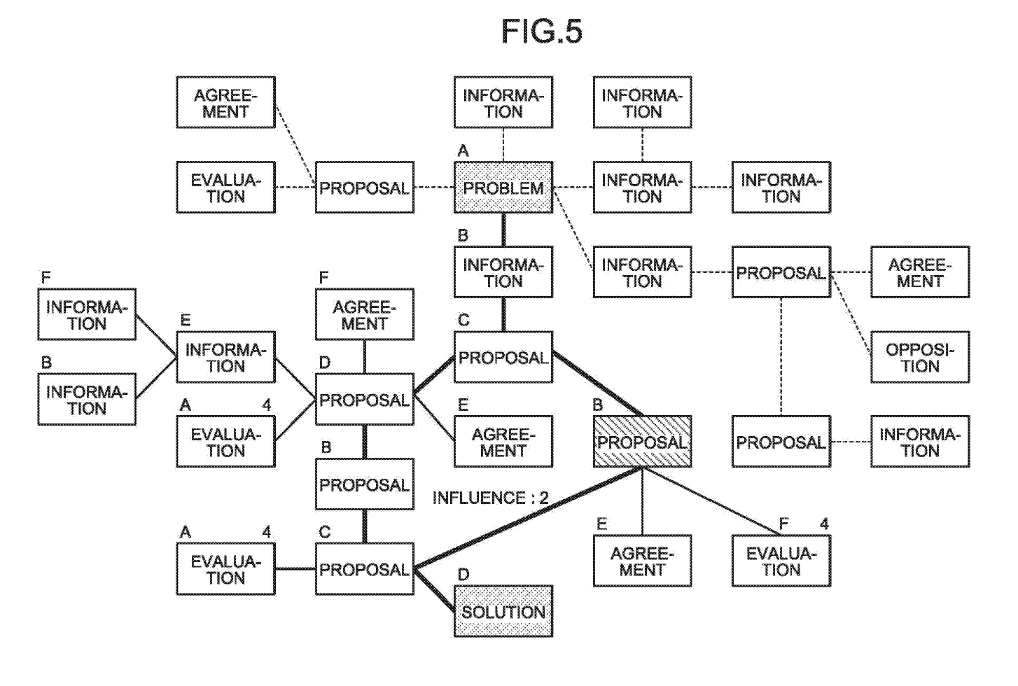

The tree diagram DB 14 is a database that stores a tree diagram that is generated with nodes and links. Specifically, the tree diagram DB 14 stores a tree diagram obtained by visualizing the discussion. FIG. 5 is a diagram representing exemplary information that is stored in the tree diagram DB 14. As illustrated in FIG. 5, the tree diagram DB 14 stores the result of the discussion on the node of “problem” generated by User A.

A node of “information” represents information that is generated with respect to the problem or another node and is classified into “intelligence” of the rough classification and “knowledge” of the intermediate classification. A node of “proposal” represents the content that is proposed with respect to the problem and another node and is classified into “intelligence” of the rough classification and “idea” of the intermediate classification. A node of “agreement” represents that there is agreement with the proposal and a node of “opposition” represents that there is opposition to the proposal and they are classified into “intelligence” of the rough classification and “determination” of the intermediate classification. Similarly, a node of “evaluation” represents that the proposal is evaluated and is classified into “intelligence” of the rough classification and “determination” of the intermediate classification. A node of “solution” represents a solution to the problem.

A link of “influence” represents that it is a node influenced by a node. According to the case represented in FIG. 5, it is represented that the node of “proposal” generated by User C is influenced by the node of “proposal” generated by User B and two points are added to the node of “proposal” generated by User B.

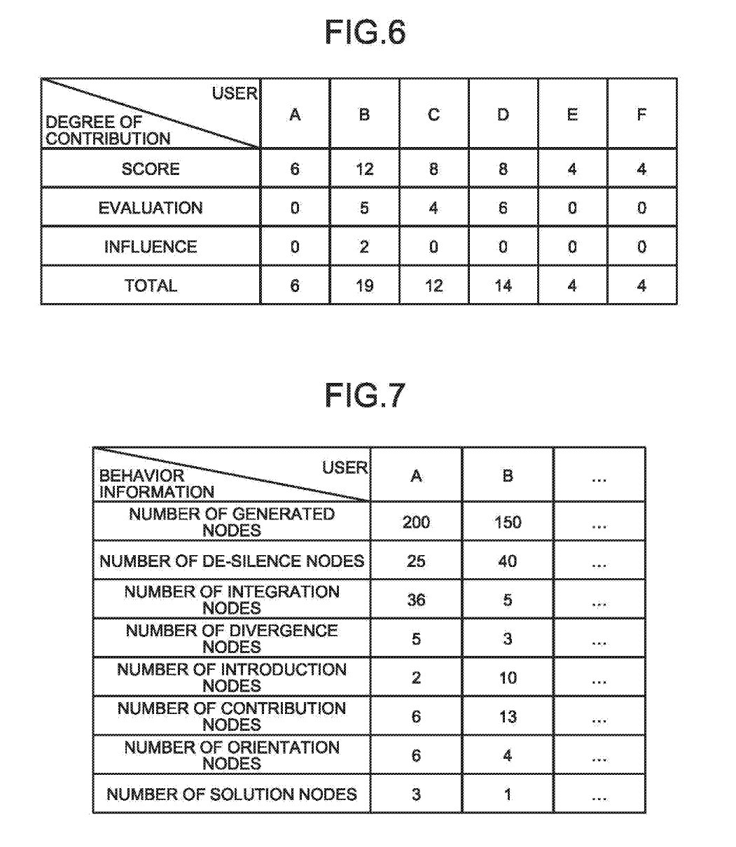

The contribution degree DB 15 is a database that records the degrees of contribution of the users in each discussion. Specifically, the contribution degree DB 15 stores, with respect to each discussion on each problem, the scores the users obtain in the discussion, the scores by which the users are evaluated, and the sums of the scores each representing the influence of a user on other users. FIG. 6 is a table of exemplary information that is stored in the contribution degree DB 15. The example represented in FIG. 6 represents the degree of contribution of each user in the tree diagram represented in FIG. 5.

As represented in FIG. 6, the contribution degree DB 15 stores “score, evaluation, influence and sum” with respect to each user. The “score” stored herein represents the sum of points obtained by the nodes generated by the user, the “evaluation” represents the sum of points by each of which the node generated by a user is evaluated by another user. The “influence” is the sum of points by each of which the node generated by a user influences another user. The “sum” is the sum of the “score, evaluation, and influence”. According to the example represented in FIG. 6, the points with respect to User B is “19 points” that is the sum of “score=12, evaluation=5 and influence=2”.

The behavior DB 16 is a database that stores information on the behavior of each user. Specifically, the behavior DB 16 stores information that specifies which behaviors correspond the nodes generated by the user.

FIG. 7 is a table representing exemplary information that is stored in the behavior DB 16. As represented in FIG. 7, the behavior DB 16 stores the “user and behavior information” in association with each other. The “user” stored herein is information that identifies users and is, for example, user names and IDs. The “behavior information” is information representing the types to which the nodes generated by the user correspond and representing behaviors to which the nodes correspond.

The “behavior information” includes, regarding the nodes generated by the user, “the number of generated nodes, the number of de-silence nodes, the number of integration nodes, the number of divergence nodes, the number of introduction nodes, the number of contribution nodes, the number of orientation nodes, and the number of solution nodes”. The “number of generated nodes” is the total number of nodes generated by the user in the creativity support system regardless projects and problems. The “number of de-silence nodes” is the number of nodes generated by the user when nobody has generated any node for a given period with respect to a problem, i.e., the number of nodes that break the silence.

The “number of integration nodes” is the total number of generated nodes each integrating multiple branched nodes in the tree diagram. The integration nodes may be recognized as nodes that connect to “integration” of the link type. In other words, the “number of integration nodes” is the total number of nodes each integrating opinions. “The number of divergence nodes is the total number of nodes from each of which multiple nodes branched off. The divergence nodes may be recognized as nodes that connect to “divergence” of the link type. In other words, the “number of divergence nodes” is the total number of nodes each causing divergent opinions. The “number of introduction nodes” is the total number of nodes that provide nodes each relating to another project or new information. In other words, the “number of introduction nodes” is the total number of nodes each providing a new opinion. The “number of contribution nodes” is the total number of nodes each contributing to solution to the problem. The “number of orientation nodes” is the total number of nodes each connecting to solution to the problem among multiple nodes that are generated with respect to one node. The “number of solution nodes” is the total number of nodes each leading to solution to the problem.

According to the example represented in FIG. 7, the number of nodes generated by User A is 200 and, specifically, User A generates 25 de-silence nodes, 36 integration nodes, five divergence nodes, two introduction nodes, six contribution nodes, six orientation nodes, and three solution nodes.

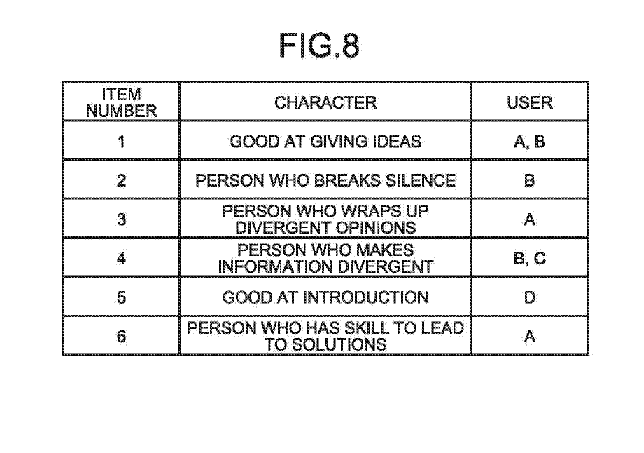

FIG. 3 will be referred back here. The character DB 17 is a database that stores information on characters corresponding to the users. FIG. 8 is a table representing exemplary information that is stored in the character DB 17. As represented in FIG. 8, the character DB 17 stores “item number, character, and user” in association with one another. The “item number” stored herein is the identifying number of the record, the “character” is the character that is specified according to the behavior of the user, etc., and the “user” is the user corresponding to the character. According to the case in FIG. 8, it is represented that the users corresponding to “good at giving ideas” of Item Number 1 are “User A” and “User B”.

The control unit 20 is a processing unit that controls the overall creativity support server 10. The control unit 20 is, for example, a processor. The control unit 20 includes a structuring unit 21, a contribution degree determination unit 26, and a support unit 30. The structuring unit 21, the contribution degree determination unit 26, and the support unit 30 are an exemplary electronic circuit of the processor and an exemplary process that is executed by the processor.

The structuring unit 21 is a processing unit that accepts generation of nodes and links and structures a discussion. In other words, the structuring unit 21 generates a tree diagram to visualize the discussion. The structuring unit 21 includes an accepting unit 22 and a generation unit 23. The structuring unit 21 performs a general log-in process with respect to a user and executes subsequent processes to the user who is permitted to log in.

The accepting unit 22 is a processing unit that accepts nodes and links from the user terminals 1. For example, the accepting unit 22 displays the top screen of a creativity system screen on the user terminal 1 of a user who is permitted to log in. The accepting unit 22 accepts an instruction for generating various nodes of, for example, “problem”, “proposal”, and “agreement” or an instruction for generating a link on the creativity system screen corresponding to a problem that is selected from multiple problems. Upon accepting a generation instruction, the accepting unit 22 issues a request for a process of generating a node or a link to the generation unit 23.

The generation unit 23 is a processing unit that, according to an instruction for generating a node or a link accepted by the accepting unit 22, generates a node or a link and structures a discussion to generate a tree diagram. Specifically, the generation unit 23 displays the “type”, “rough classification”, etc., which are stored in the node-link information DB 13 represented in FIG. 4, on the creativity system screen that is displayed on the user terminal 1 and accepts the information on a node to be generated from a user. The generation unit 23 then generates a “node” corresponding to the accepted information.

After generating the “node”, the generation unit 23 further displays, for example, the “type” of link stored in the node-link information DB 13 represented in FIG. 4. Upon accepting selection from the user, the generation unit 23 sets the accepted link between nodes. When the generation unit 23 does not accept any selection from the user, the generation unit 23 does not set any link between nodes. To each node, a timestamp representing the date at which the node is generated is assigned. Because nodes are assigned with timestamps, each node can be managed uniquely. For example, node numbers may be assigned according to the order in which the nodes are registered to manage the nodes.

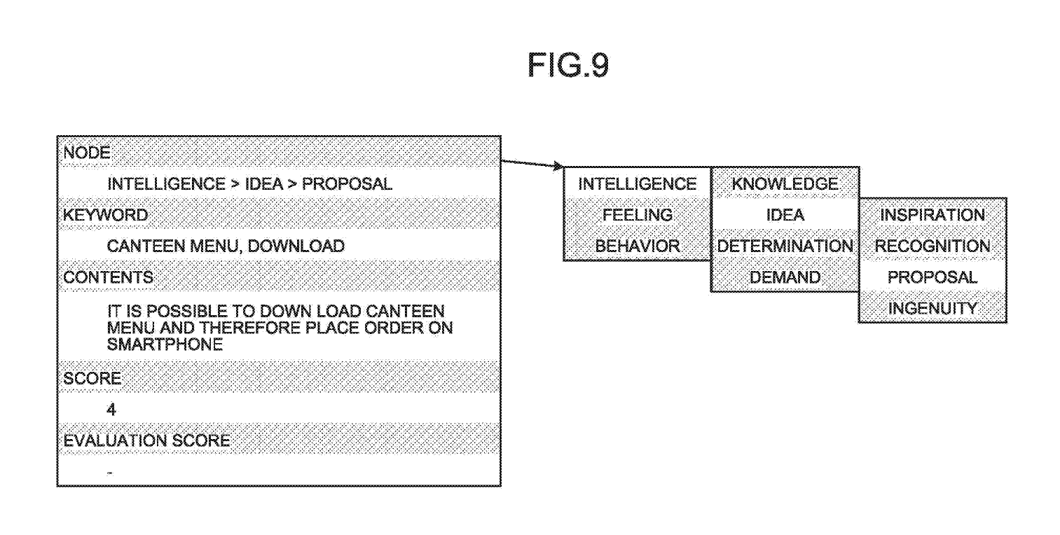

Generation of nodes will be described. FIG. 9 is a diagram illustrating the details of a proposal node. The proposal node represented in FIG. 9 is a node corresponding to a node of “proposal”. As represented in FIG. 9, the generation unit 23 displays the rough classification of “intelligence, feeling, and behavior” and accepts selection of a node to be generated from the pulldown menu corresponding to each class. According to the example represented in FIG. 9, an example is represented in which “proposal” of the fine classification of “idea” of the intermediate classification of “intelligence” of the rough classification is selected.

The generation unit 23 then accepts an input of “canteen menu, download” as keywords corresponding to this node and accepts the content of a new proposal “it is possible to downloading a canteen menu and therefore place an order on a smartphone”. The generation unit 23 then specifies the score of “four points” corresponding to “proposal” of the fine classification of nodes from the node-link information DB 13 represented in FIG. 4 and sets the score with respect to the node. In this manner, the generation unit 23 accepts an input of a node of “proposal” and generates a node.

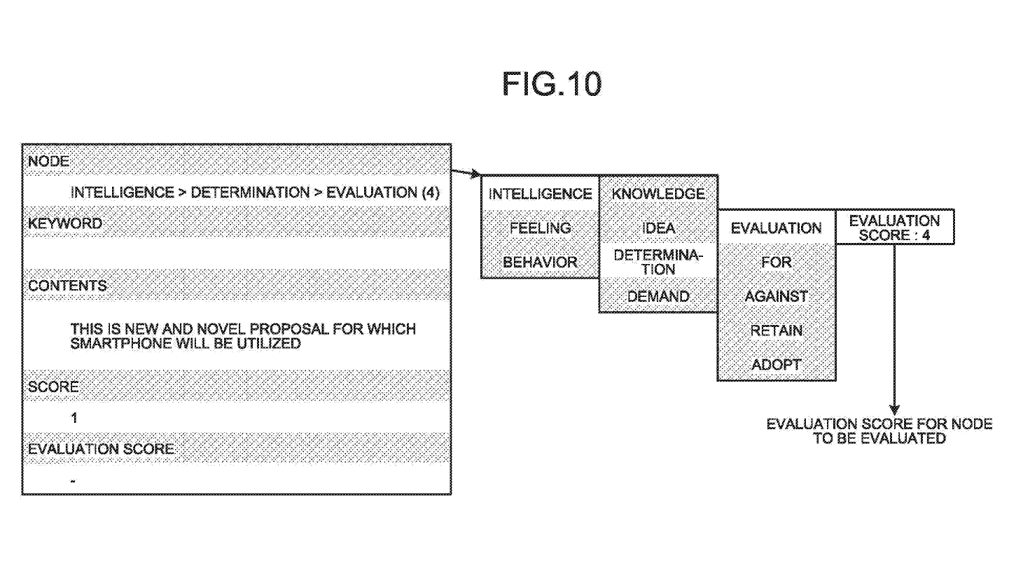

An evaluation node will be described here. FIG. 10 is a diagram illustrating the details of an evaluation node. The evaluation node represented in FIG. 10 is a node corresponding to a node of “evaluation”. As represented in FIG. 10, the generation unit 23 displays the rough classification of “intelligence, feeling, and behavior” and accepts selection of a node to be generated from the pulldown menu corresponding to each class. According to the example represented in FIG. 10, the example is represented in which “four points” of “evaluation” of the fine classification of “determination” of the intermediate classification of “intelligence” of the rough classification is selected. The evaluation scores according to FIG. 9 and FIG. 10 are the scores of evaluation on the node made by others.

The generation unit 23 then accepts the content of evaluation “this is a new and novel proposal for which smartphones will be utilized” to be set with respect to the node. The generation unit 23 specifies the score of “one point” corresponding to “evaluation” of the fine classification of nodes from the node-link information DB 13 represented in FIG. 4 and sets the score with respect to the node. In this manner, the generation unit 23 accepts an input of a node of “evaluation” and generates a node.

Generation of a link will be described with FIG. 5. Suppose that, according to an instruction from User C, the generation unit 23 generates a node of “proposal” with respect to a node of “proposal” from User B. The generation unit 23 displays a menu, or the like, that allows selection of “type” of “link” around the generated node of “proposal”. When “influence” of “type” is selected, the generation unit 23 assigns the score of “two points” corresponding to the type of “influence” to the node of “proposal” of the user B. In this manner, the generation unit 23 accepts an input of “link” between the nodes and generates a link.

The contribution degree determination unit 26 is a processing unit including an evaluation tallying unit 27 and a character specifying unit 28 that tally the degree of contribution of each user with respect to the discussion in which the solution to the problem is generated.

The evaluation tallying unit 27 is a processing unit that, with respect to the nodes from the node of “problem” to the node of “solution”, tallies the “scores” obtained according to classification of each node and the “evaluation scores” obtained according to the links, etc., to evaluate the degree of contribution of each user. The evaluation tallying unit 27 stores the degree of contribution of each user in the contribution degree DB 15 and issues an instruction for starting the process to the character specifying unit 28.

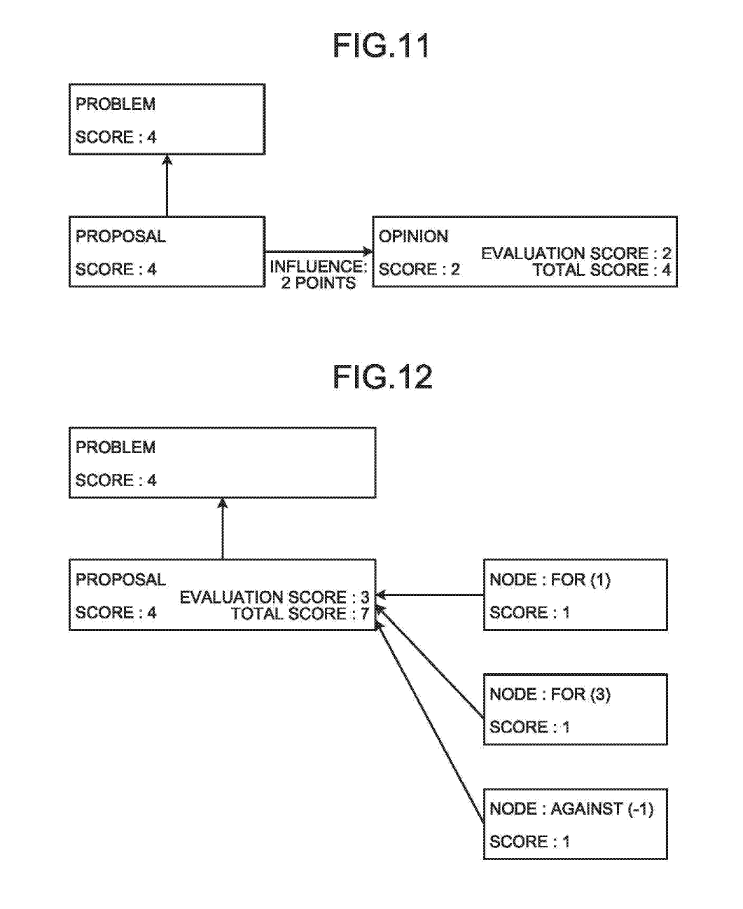

An exemplary evaluation method will be described here. FIG. 11 is a diagram illustrating exemplary calculation of the degree of contribution of a proposal. As represented in FIG. 11, according to the information that is stored in the node-link information DB 13 represented in FIG. 4, the evaluation tallying unit 27 calculates a score of “four points” as the degree of contribution with respect to the node of “problem” and calculates a score of “four points” with respect to the node of “proposal”. Furthermore, according to the information that is stored in the node-link information DB 13 represented in FIG. 4, the evaluation tallying unit 27 calculates a score of “two points” with respect to the node of “opinion” and, because a link of “influence” is set, further adds evaluation score of “two points” to calculate “four points” as the total score. In other words, when the opinion proposed before is referred to propose a node of “proposal”, the evaluation tallying unit 27 also evaluates the original opinion.

An exemplary calculation of the degree of contribution according to evaluation on another node will be described. FIG. 12 is a diagram illustrating exemplary calculation of the degree of contribution according to evaluation. As represented in FIG. 12, according to the information that is stored in the node-link information DB 13 represented in FIG. 4, the evaluation tallying unit 27 calculates a score of “four points” with respect to a node of “problem” as the degree of contribution and calculates a score of “four points” with respect to a node of “proposal”. The evaluation tallying unit 27 also calculates a score of “one point” with respect to a node of “agreement”, a node of “evaluation”, and a node of “opposition” that are evaluation nodes with respect to the node of “proposal”. The evaluation tallying unit 27 detects that, with respect to the node of “proposal”, an evaluation score of “one point” is assigned from the node of “agreement”, an evaluation score of “three points” is assigned from the node of “agreement”, and an evaluation score of “minus one point” is assigned from the node of “opposition”. Accordingly, the evaluation tallying unit 27 calculates “seven points” as the total score obtained by adding the evaluation score of “one point, three points, and minus one point” to the original “four points”. In other words, the evaluation tallying unit 27 takes, not only the score of the node, but also the points of evaluation from others into account to calculate the total score.

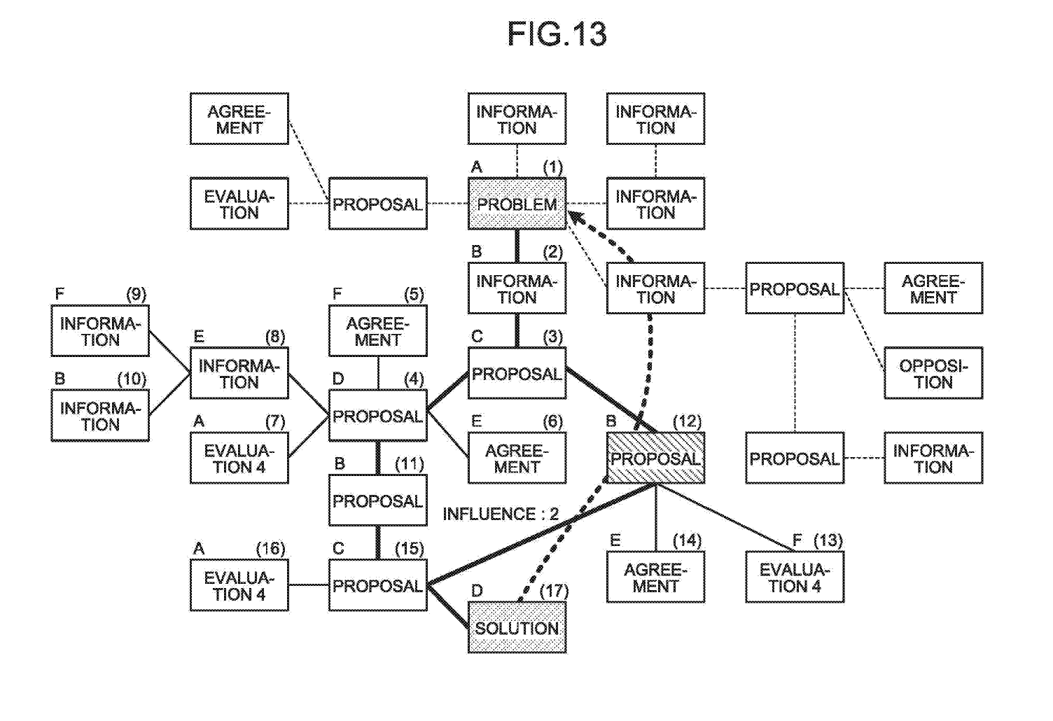

The evaluation system for a tree diagram that is visualization of a discussion using the above-described evaluation method twill be described in detail. FIG. 13 is a diagram illustrating the system for evaluation. As represented in FIG. 13, when User D derives a node of “solution” with respect to a node of “problem” that is generated by User A, the evaluation tallying unit 27 evaluates, with respect to the solution, the degree of contribution to solve each problem from the information on the past and the history of the proposal.

Specifically, first of all, the evaluation tallying unit 27 traces back from the node of “solution” to the node of “problem” and selects nodes between the node of “solution” to the node of “problem” as nodes to be evaluated. The evaluation tallying unit 27 then refers to the timestamp of each node to specify the order in which the nodes are generated (posted). Suppose that nodes are generated according to the order according to the numbers assigned to the respective nodes represented in FIG. 13.

The evaluation tallying unit 27 takes the score of the node, the evaluation score, and the scores of links into account and calculates the total score of the scores of each node in a descending order of the timestamps. For example, with respect to the node of “problem” with Timestamp 1, the evaluation tallying unit 27 calculates a score of “four points” of the node as the total score. Furthermore, with respect to the node of “information” with Timestamp 2, the evaluation tallying unit 27 calculates a score of “two points” of the node as the total score.

With respect to the node of “proposal” with Timestamp 4, the evaluation tallying unit 27 calculates, as the total score, “10 points” that is obtained by adding, to the score of “4 points” of the node, the evaluation score of “one point” from the node of “agreement” with Timestamp 5, the evaluation score of “one point” from the node of “agreement” with Timestamp 6, and the evaluation score of “4 points” from the node of “evaluation” with Timestamp 7.

Furthermore, with respect to the node of “proposal” with Timestamp 12, the evaluation tallying unit 27 calculates, as the total score, “11 points” that is obtained by adding, to the score of “4 points” of the node, the evaluation score of “4 points” from the node of “evaluation” with Timestamp 13, the evaluation score of “one point” from the node of “agreement” with Timestamp 14, and the evaluation score of “two points” on the link of “influence” from the node of “proposal” with Timestamp 15.

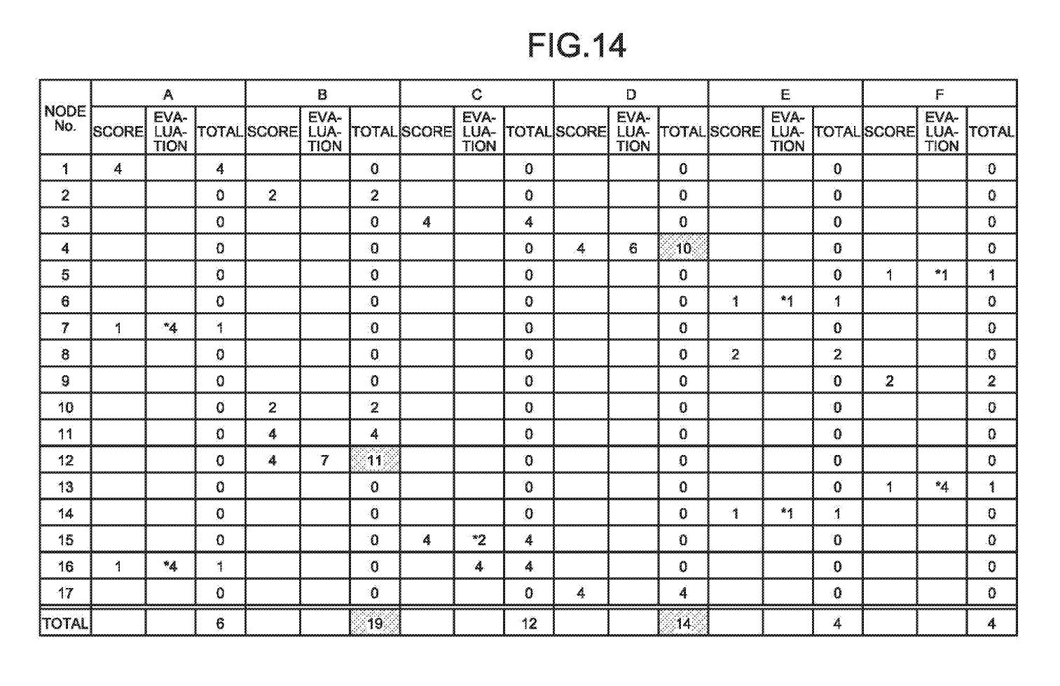

In this manner, the evaluation tallying unit 27 calculates the total score with respect to each of the nodes with Timestamps 1 to 17 represented in FIG. 13. The result of calculating the total score is represented in FIG. 14. FIG. 14 is a table illustrating the evaluation of each node. FIG. 14 represents the degree of contribution of each user in the tree diagram represented in FIG. 13. The node No. represented in FIG. 14 denotes the order of Timestamps described with FIG. 13. In other words, according to FIG. 14, the node of “problem” with Timestamp 1 corresponds to Node No. 1.

For example, with respect to User A, the total score of No. 1, No. 7 and No. 16 generated by User A is calculated as the degree of contribution. Specifically, with respect to User A, the total score of “4 points” are calculated with respect to Node No. 1, the total score of “one point” is calculated with respect to Node No. 7, and the total score of “one point” is calculated with respect to Node No. 16 and accordingly the degree of contribution is “4+1+1=6 points”. Note that “*” with respect to Node No. 7 and Node No. 16 represents the evaluation scores to other nodes. In other words, it is represented that, with respect to Node No. 7, User A assigns an evaluation score of “four points” to Node No. 4 that is another node.

Furthermore, with respect to User B, the total score of “two points” are calculated with respect to Node No. 2, the total score of “two points” are calculated with respect to Node No. 10, the total score of “four points” are calculated with respect to Node No. 11, and the total score of “11 points” are calculated with respect to Node No. 12 and the degree of contribution is “2+2+4+11=19 points”.

Furthermore, with respect to User C, the total score of “four points” are calculated with respect to Node No. 3, the total score of “four points” are calculated with respect to Node No. 15, and the evaluation score of “four points” from Node No. 16 are calculated and the degree of contribution is “4+4+4=12 points”. According to the above-described method, the degree of contribution of “14 points” is calculated with respect to User D, the degree of contribution of “four points” is calculated with respect to User E, and the degree of contribution of “four points” is calculated with respect to User F. The evaluation tallying unit 27 then calculates the score, evaluation, influence, and sum of each user by using the result represented in FIG. 14 and stores them in the contribution degree DB 15.

The character specifying unit 28 is a processing unit that specifies the character of a user who generates nodes by using the result of tallying performed by the evaluation tallying unit 27. Specifically, with respect to each individual, the character specifying unit 28 accumulates behaviors in the past and specifies a behavior from from the accumulated behaviors. For example, the character specifying unit 28 tallies the behavior information stored as represented in FIG. 7 from the tree diagram of each problem stored in the tree diagram DB 14. The character specifying unit 28 then compares the number of tallied nodes with a threshold to specify which one of characters stored in the character DB 17 represented in FIG. 8 corresponds to the user.

Determination on behavior information will be described here. For example, the character specifying unit 28 calculates, as the “number of generated nodes”, the result of tallying the number of nodes generated by the user with respect to each problem. Furthermore, with respect to each problem, the character specifying unit 28 increments the “number of solution nodes” generated by the user who generates a “solution” to each problem.

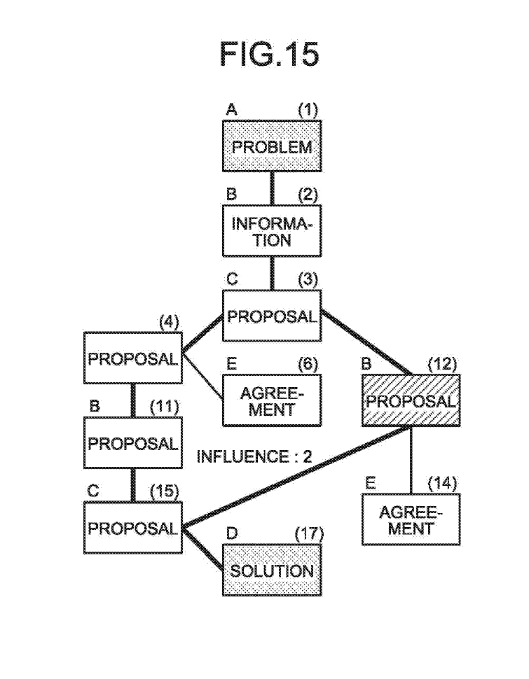

When User C generates a node in a state where no one has generated any node within a given time, such as one hour, since the last generation of node, the character specifying unit 28 increments “the number of de-silence nodes” generated by User C. FIG. 15 is a diagram illustrating an exemplary de-silence node. Suppose that, as illustrated in FIG. 15, User C generates a node of “proposal” with Timestamp 15 after one hour after generation of nodes with Timestamps 11 and 12. In this case, the character specifying unit 28 increments the “number of de-silence nodes” generated by User C.

When, in a state where nodes are divergent, User C generates a node that integrates the divergence, the character specifying unit 28 increments the “number of integration nodes” generated by User C. For example, suppose that User A, User B, and User C generate nodes of “proposal” respectively with respect to a node of “proposal” and accordingly the tree diagram diverges. When a node of “proposal” generated thereafter by User C is linked with each node generated according to the discussion derived from each of the nodes of “proposal”, the character specifying unit 28 determines that the node of “proposal” generated by User C is an integration node. It can be determined also from “integration” of the link classification.

When User C generates a node that causes the discussion to diverge, the character specifying unit 28 increments “the number of divergence nodes” generated by User C. For example, suppose that, in a state where there is no branch-off from a node of “problem” and nodes are generated, multiple branch-offs occur from the node of “proposal” generated by User C. In this case, the character specifying unit 28 determines that the node of “proposal” generated by User C as a divergence node. The determination can be made from “separation” of link classification.

When User C generates a node that activates a discussion in a state where the discussion stagnates, the character specifying unit 28 increments the “number of introduction nodes” generated by User C. For example, suppose that, after a given time (for example, 30 minutes) after generation of the last node, User C generates nodes that are, in number, equal to or larger than a threshold, such as 10, within a given time, such as 10 minutes, with respect to a node of “proposal” generated by User C. In this case, the character specifying unit 28 determines that the node of “proposal” generated by User C as an introduction node.

When User C generates a node that influences solution to a problem, the character specifying unit 28 increments “the number of contribution nodes” generated by User C. For example, the character specifying unit 28 refers to the contribution degree DB 15 generated with respect to a problem and increments “the number of contribution nodes” generated by the user who generates nodes that are, in number, equal to or larger than a threshold in total. In another example, the character specifying unit 28 refers to FIG. 14 generated by the evaluation tallying unit 27 and increments “the number of contribution nodes” generated by each user who generates nodes that are, in number, equal to or larger than the threshold in total.

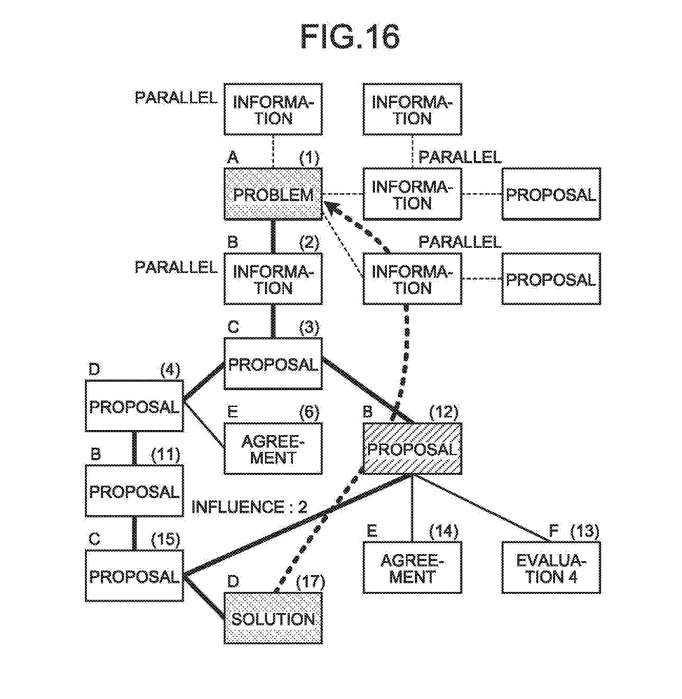

When User C generates a node that determines orientation to solve a problem, the character specifying unit 28 increments “the number of orientation nodes” generated by User C. FIG. 16 is a diagram illustrating an exemplary orientation node. According to the case represented in FIG. 16, four nodes of “information” are connected in parallel to Node 1 with Timestamp 1. Then nodes of “proposal” are connected to the nodes of “information” at three positions. The nodes were likely to develop according to their respective points of view; however, the proposal of Node 3 leads to a conclusion finally. In this case, the character specifying unit 28 compared the proposal of Node 3 with other proposals and evaluates the proposal of Node 3 as a proposal that gives orientation.

Using that result, the character specifying unit 28 specifies the character of the user, which will be described by exemplifying the case represented in FIG. 7. For example, the character specifying unit 28 specifies User A and User B each having generated 100 or more nodes as users corresponding to “good at giving ideas” represented in FIG. 8 and adds them to the item of “user” in FIG. 8. It is possible to specify users corresponding to “good at giving ideas” also by counting the number of proposal nodes. The character specifying unit 28 specifies User B who has generated 40 or more de-silence nodes as a user corresponding to “person who breaks the silence” represented in FIG. 8 and adds User B to the item of “user” represented in FIG. 8.

The character specifying unit 28 specifies User A who has generated 30 or more integration nodes as a user corresponding to “person who wraps up divergent opinions” and adds User A to the item of “user” represented in FIG. 8. The character specifying unit 28 specifies User A who has generated five or more divergence nodes as a user corresponding to “person who causes divergent information” represented in FIG. 8 and adds User A to the item of “user” represented in FIG. 8.

The character specifying unit 28 specifies User B who has generated 10 or more introduction nodes as a user corresponding to “person who is good at introduction” represented in FIG. 8 and adds User B to the item of “user” represented in FIG. 8. The character specifying unit 28 specifies User B who has generated eight or more contribution nodes, a user who has generated five or more orientation nodes, or a user who has generated three or more solution nodes as a user corresponding to “person who has the skill to derive solutions” represented in FIG. 8 and adds the user to the item of “user” represented in FIG. 8.

The thresholds are examples only and the setting may be changed to any value. The example where one user corresponds to multiple characters has been described above. Alternatively, for example, the character specifying unit 28 may specify, among the sets of behavior information exceeding a threshold, a set of behavior information with the largest difference from the threshold as a character.

FIG. 3 will be referred back here. The support unit 30 is a processing unit that supports activation of discussion. Specifically, the support unit 30 includes a command analysis unit 31 and an activation unit 32. According to the situation where the discussion stagnates, the support unit 30 estimates a character enabling the discussion to be active to induce activation of the discussion.

The command analysis unit 31 analyzes the information retrieved or input by a user and performs creativity support. For example, the command analysis unit 31 acquires a search word input by a user on, for example, a webpage, specifies a node for which the search word is input as a keyword from nodes in the past, and notifies the user of the node. The command analysis unit 31 supports the creativity of the user by notifying the user of the antonym to the search word or by notifying the user of a node for which the antonym is input as a keyword.

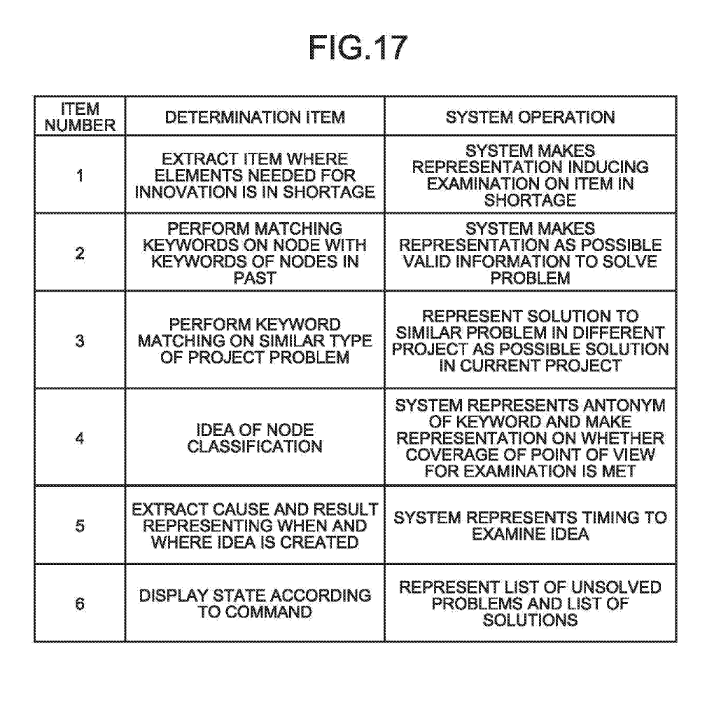

The activation unit 32 is a processing unit that activates a discussion. Specifically, the activation unit 32 determines the classification of nodes constituting a tree structure that visualizes a discussion and the situation in which the nodes are generated, estimates hindrance of activation according to the result of the determination, and executes recognition support with respect to, for example, a new point of view, to the users who participate in the discussion. The item of recognition support will be described. FIG. 17 is a table illustrating exemplary items of recognition support.

As represented in FIG. 17, the activation unit 32 manages “item number, determination item, and system operation” in association with one another. The “item number” is information that identifies the items of support, the “determination item” is an of determination item for determining the situation of discussion, and the “system operation” is an exemplary content of support executed by the activation unit 32.

For example, when an item where elements needed for innovation are in shortage can be extracted according to classification of nodes, the activation unit 32 represents a message inducing examination on the item in shortage to the user. In other words, the activation unit 32 specifies the types of nodes and the number of nodes of the types and represents the class in shortage to the users to provide support with respect to a new point of view. For example, when the number of nodes of “proposal” is smaller than a threshold, the activation unit 32 represents a message indicating that the number of nodes of “proposal” is small.

Furthermore, the activation unit 32 performs matching on the keywords on nodes with keywords of nodes in the past and represents possible valid information toward solution of the problem to the user. In other words, the activation unit 32 represents nodes that may be connected to solution to the problem from the tree diagram in the past to the users to provide support with respect to a new point of view. For example, when there are few actions to a keyword “AAA” of a node of “proposal” generated with respect to Problem A, the activation unit 32 specifies nodes that include the keyword “AAA” and nodes that are connected to the keyword “AAA” with links from the tree diagram generated with respect to another problem and represents the nodes to the users.

The activation unit 32 further performs keyword matching on a similar tree diagram of a project of a project and represents, to the users, a solution to the similar problem in the different project as a possible solution in the current project. In other words, the activation unit 32 matches different discussions on the same problem to provide support with respect to a new point of view. For example, with respect to a tree diagram of Group A that discusses Problem A and a tree diagram of Group B that discusses Problem A, the activation unit 32 counts the numbers of nodes of each type. The activation unit 32 then represents the class with fewer nodes than those of Group B to the users of Group A.

When the class of a node is idea, the activation unit 32 represents, to the user, the antonym of the keyword and whether the completeness of perspective to consider the solution of the problem is met. Specifically, the activation unit 32 specifies the keyword of a node corresponding to “idea” of the intermediate classification among the nodes of the tree diagram and represents the antonym of the keyword and a field less relevant to the keyword to the user to provide support with respect to a new point of view. For example, when the keyword is “convenience to users increases”, the activation unit 32 represents the antonym “inconvenience” to provide support with respect to a new point of view. When the keyword is “downloading a canteen menu”, the activation unit 32 represents a point of view regarding space, such as, “eating tour” or “takeout” as a less-relevant field, thereby providing recognition. To specify the antonym or field, known various dictionaries may be used.

The activation unit 32 extracts the cause and result representing when and where an idea is created and represents the timing to examine the idea to a user. Specifically, the activation unit 32 compares the schedule information on User A that is registered in advance and the time points at which nodes are generated, specifies the time period during which a large number of nodes are generated, and represents the time period to the user.

The activation unit 32 displays the state according to a command that is specified in advance, thereby representing a list of unsolved problems and a list of solutions. Specifically, upon accepting a specification command from User A, the activation unit 32 represents a tree diagram on a problem in which User A participates and a tree diagram on a problem in which User A does not participate, thereby increasing the motivation of User A for creativity.

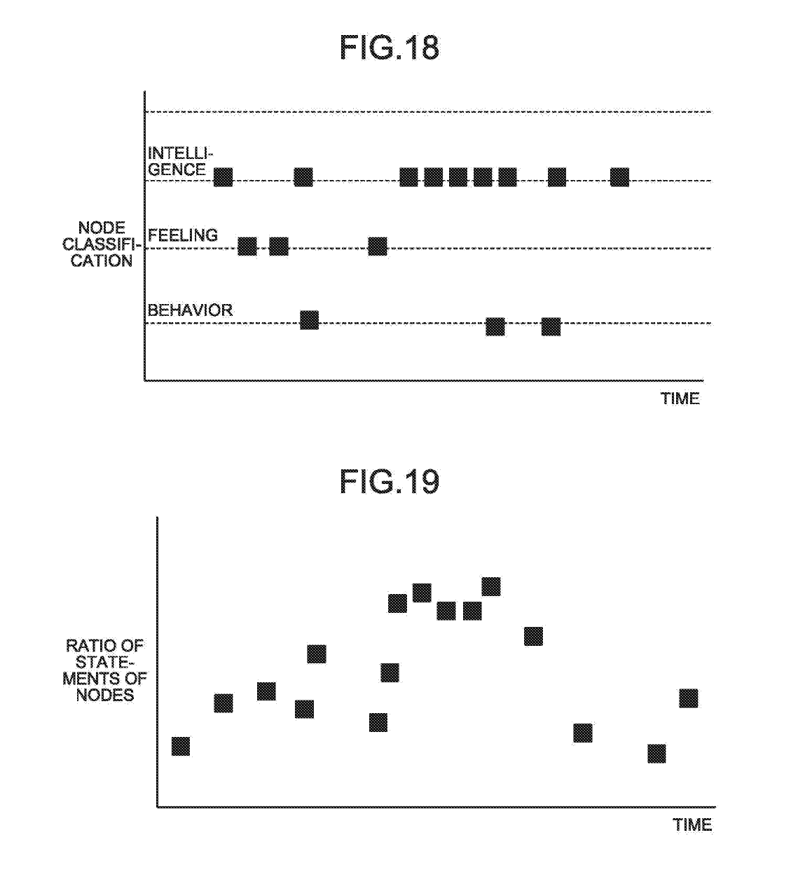

Exemplary determination on support creativity made by the activation unit 32 will be described here. FIG. 18 is a graph illustrating exemplary support implemented by visualization of classification of nodes. As represented in FIG. 18, with respect to a tree diagram with respect to a problem, the activation unit 32 classifies each of the nodes excluding the problem node and the solution node into any one of “intelligence, feeling, and behavior” of the rough classification and displays each of the nodes according to each generation time point. According to the example represented in FIG. 18, the activation unit 32 specifies that nodes of “feeling” decreases in number as the time goes. Accordingly, the activation unit 32 sends a message representing that the number of nodes of “feeling” is small to each user.

FIG. 19 is a diagram illustrating exemplary support by visualization of the number of statements of nodes. As illustrated in FIG. 19, the activation unit 32 plots the number of generated nodes (the number of statements) according to the time points. Accordingly, the activation unit 32 transmits a message indicating that the number of statements is decreasing to each user. By changing the horizontal axis from time point to time period, the activation unit 32 is able to specify the time periods in which there are a lot of statements and there are few statements and notify the user of the time periods. The activation unit 32 may change the color to be displayed such that nodes concentrating on information and opinion and nodes with high evaluation scores can be distinguished.

With respect to a project where the discussion stagnates, the activation unit 32 may issue a request for participating in a discussion to a user who activates the discussion. For example, when the discussion of Group A stagnates and there are few nodes, the activation unit 32 may induce users corresponding to the character “good at giving ideas” among Group B to participate in Group A.

Flow of Overall Process

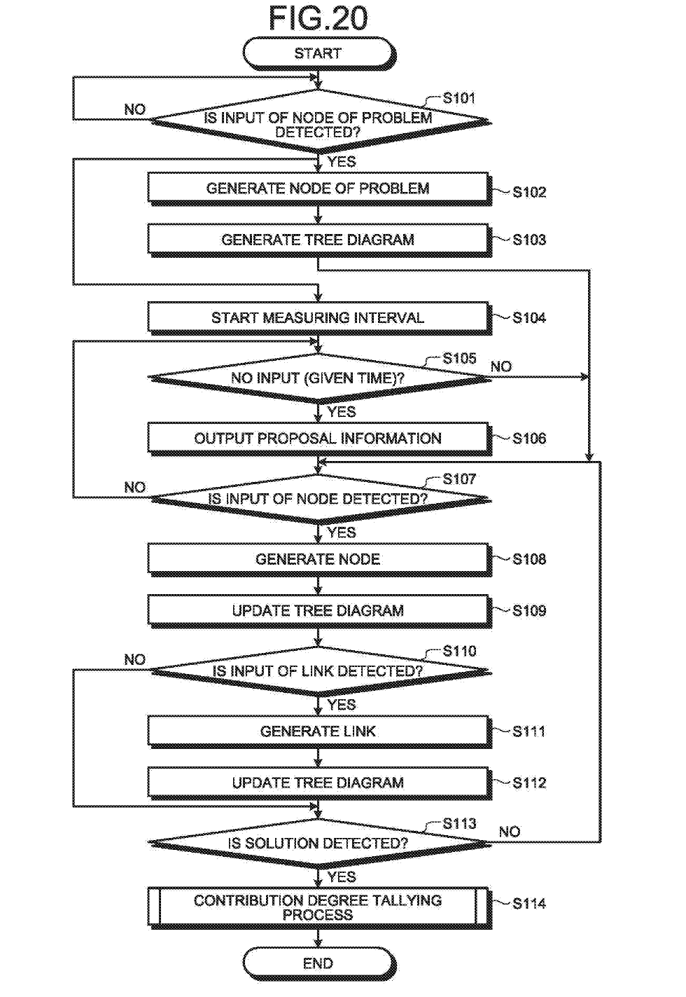

FIG. 20 is a flowchart representing the flow of the overall process. As represented in FIG. 20, when the accepting unit 22 detects an input of a node of a problem (YES at step S101), the generation unit 23 generates a node of “problem” (S102) and generates a tree diagram (S103).

When an input of a node of a problem is detected (YES at step S101), the activation unit 32 starts measuring the interval (S104) and, when the time period during which no input has been made exceeds a given time period (YES at 5105) outputs proposal information (S106). For example, when no node is generated for a given time from when a node is generated, the activation unit 32 transmits a message inducing generation of a node to each user.

When the accepting unit 22 detects an input of a node (YES at S107), the generation unit 23 generates a node according to the detected content (S108) and updates the tree diagram (S109). When no input of node is detected (NO at S107), 5105 and the following steps are repeated.

When the reception unit 22 detects an input of a link (YES at S110), the generation unit 23 generates a link according to the detected content (S111) and updates the tree diagram (5112). When no input of link is detected (NO at S110), S113 and the following steps are executed.

When any node of “solution” is not detected (NO at S113), S107 and the following steps are repeated. When a node of “solution” is detected (YES at S113), the process of tallying the degrees of contribution is executed (step S114). In the case of a problem being examined and not reaching a solution, it is not possible to follow nodes from a solution; therefore the nodes may be followed from the problem to perform various types of evaluation including one on the provisional degree of contribution.

Flow of Tallying Degrees of Contribution

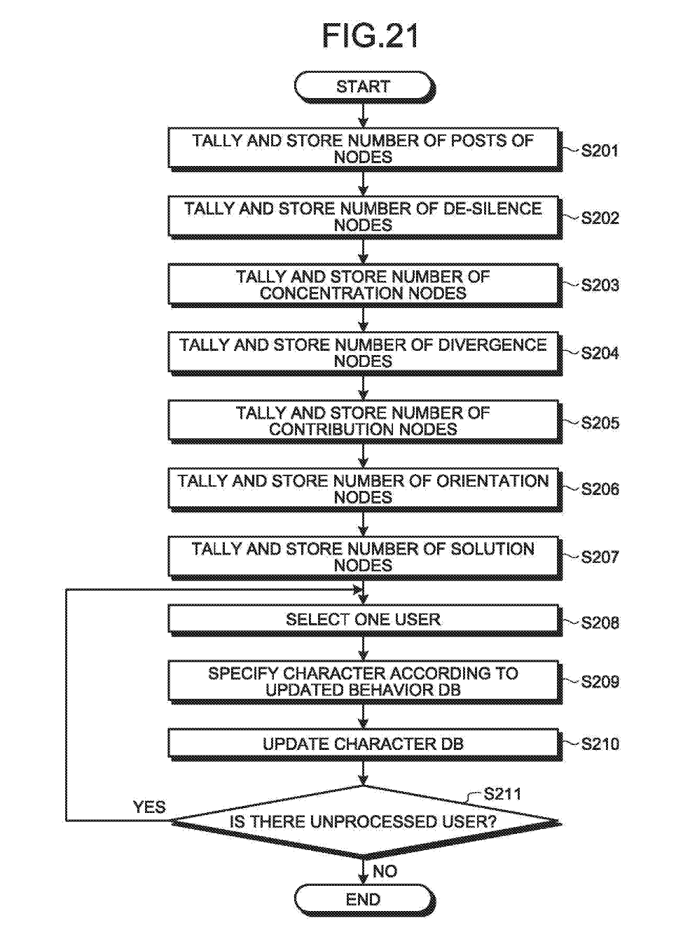

FIG. 21 is a flowchart of the flow of a process of tallying the degrees of contribution. As represented in FIG. 21, the evaluation tallying unit 27 executes the flowing process on each tree diagram that is generated for each problem. Specifically, the evaluation tallying unit 27 tallies the number of generated nodes and stores it in the behavior DB 16 (S201) and tallies the number of de-silence nodes and stores it in the behavior DB 16 (S202).

The evaluation tallying unit 27 tallies the number of concentration nodes and stores it in the behavior DB 16 (S203), tallies the number of divergence nodes and stores it in the behavior DB 16 (S204), tallies the number of contribution nodes and stores it in the behavior DB 16 (S205).

The evaluation tallying unit 27 tallies the number of orientation nodes and stores it in the behavior DB 16 (S206) and tallies the number of resolution nodes and stores it in the behavior DB 16 (S207).

The character specifying unit 28 then selects a user (S208), specifies the character according to the updated behavior DB 16 (5209), and updates the character DB 17 according to the specified character (S210). When there is an unprocessed user (YES at S211), S208 and the following steps are repeated. When there is no unprocessed user (NO at S211), the process ends.

Flow of Recognition Support Process

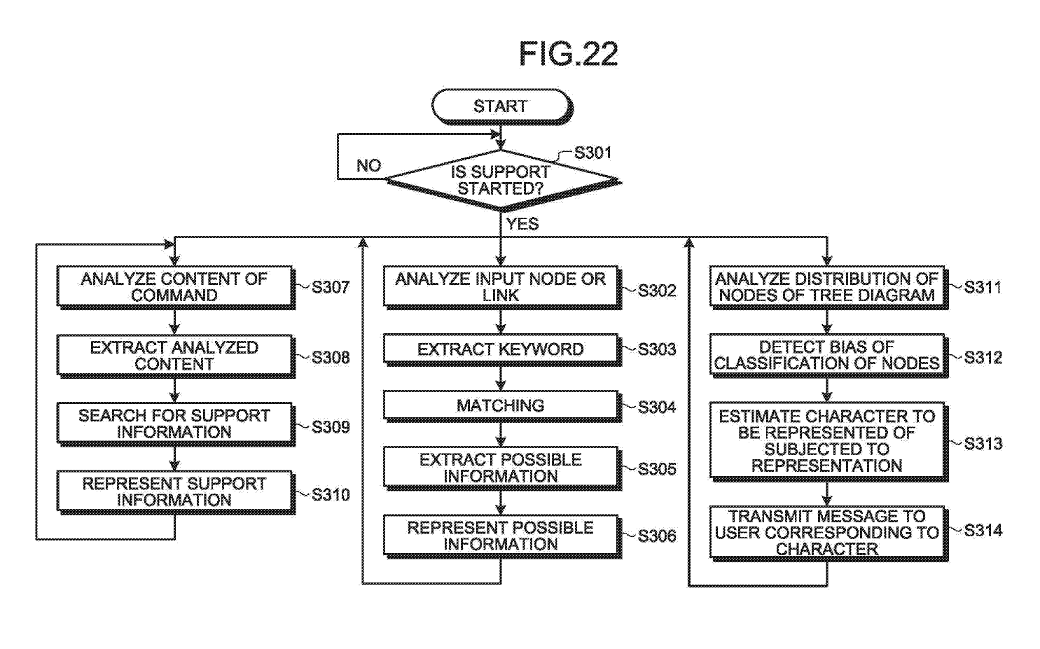

FIG. 22 is a flowchart representing the flow of a recognition support process. This process is executed not in synchronization with those represented in FIG. 20 and FIG. 21.

As represented in FIG. 22, when a node of “problem” is generated, support is started (S301) and the process from S302 to S306, the process from S307 to S310, and the process from S311 to S314 are executed in parallel.

Specifically, the activation unit 32 analyzes information on a node or a link that is input (S302) and extracts a keyword (S303). The activation unit 32 performs matching on the keyword with respect to keywords of nodes in the past (S304), extracts possible information (S305), and notifies a user of the possible information (S306). For example, the activation unit 32 extracts a node including the same keyword or a node including the antonym and notifies each member of the project of the node.

The command analysis unit 31 analyzes the content of a command that is input by a user (S307) and extracts the analyzed content (S308). The command analysis unit 31 then searches for support information (S309) and represents the support information to the user (S310). For example, the command analysis unit 31 represents a keyword that is associated with the input command to the user.

The activation unit 32 analyzes the distribution of nodes in a tree diagram (S311) and detects a bias of classification of nodes (S312). The activation unit 32 estimates a character subjected to representation (S313) and transmits a message to the user corresponding to the character (S314).

For example, when there are few generated nodes, the activation unit 32 transmits a message that induces generation of nodes to users corresponding to “good at giving ideas”. When generation of nodes stagnates, the activation unit 32 transmits a message inducing generation of nodes to users corresponding to “breaking the silence”. When nodes are divergent, the activation unit 32 sends a message inducing generation of nodes to users corresponding to “person who wraps up divergent opinions”.

When there is not divergence of nodes and the creativity is too unified, the activation unit 32 transmits a message inducing generation of a node to users corresponding to “person who causes divergent information”. When there are a lot of nodes of “proposal” and few nodes of “information”, the activation unit 32 transmits a message inducing generation of nodes to users corresponding to “person who is good at introduction”. When, while there are a lot of nodes, any solution is not derived yet, the activation unit 32 transmits a message inducing generation of a node to users corresponding to “good at deriving solutions”.

Effect

As described above, the creativity support server 10 is capable of specifying the character of each user and inducing users who activate a stagnant discussion to participate in the discussion, which enables, in addition to partial creativity support, overall creativity support and sufficient creativity support.

The creativity support server 10 analyzes new data that is input and collected data. Even when any new data is not input, the creativity support server 10 monitors the input interval and accordingly the system is able to perform autonomous analysis and send information. Furthermore, the creativity support server 10 automatically sends visualized data associated data from the system, thereby providing recognition to the users.

Furthermore, the creativity support server 10 is able to extract elements in shortage to be examined from classification of nodes that are input as information and comparison and analysis of elements needed for innovation that are registered in advance in the system. After the extraction, the creativity support server 10 issues a notification from the system, thereby providing new recognition. When users belong to a project and at the same time have individual problems, the creativity support server 10 is able to associate sets of information on the problems. Furthermore, the creativity support server 10 is capable of association with information on other users and on a project other than the project to which the user belongs.

In the creativity support server 10, the system is able to determine specialization and experiences of individuals and induce the individuals to participate as members and give answers to solve a problem. In the creativity support server 10, the system is capable of inducing persons who can answer to give answers. In the creativity support server 10, the system determines elements in shortage in a discussion and the system automatically induces a discussion.

For example, when a user acquires information that the user does not always obtain by himself/herself, the information is one that is not found by simple search. For this reason, the information can be highly evaluated and the information can be recognized as being ranked to be highly effective over the information. The creativity support server 10 visualizes individual skills and therefore the system can induce a user to give opinions even in association with another project or in the project. Accordingly, the barrier between organizations can be overcome.

### [b] Second Embodiment

The first embodiment of the invention has been described above, and the present invention may be carried out in various different modes in addition to the above-described first embodiment.

Calculation of Degree of Contribution

The first embodiment has been described by exemplifying the case where, to calculate the degree of contribution of a node, the creativity support server 10 uses the score that is set with respect to the node, the evaluation score on the node specified by others, and the score of influence that is specified by links, the creativity support server 10. Alternatively, for example, the creativity support server 10 may use the score that is set with respect to the node and the evaluation score to calculate the degree of contribution, or may use the score that is set with respect to the node and the score on, for example, influence to calculate the degree of contribution, i.e., any combination may be used. The state where a discussion stagnates may be determined according to the timestamps and when, in that state, a person provides a new proposal and the proposal is a node leading to a solution, the person is valued.

Individual Tree Diagram

The first embodiment has been described by exemplifying a group discussion. Alternatively, the same processing can be performed on an individual discussion. Alternatively, when the same problem is discussed in another group, the tree diagram of the group may be displayed to the other group and vice versa, which activates the discussions. According to the first embodiment, nodes to be evaluated are selected and the behavior information of each user is specified. Alternatively, all nodes may be used to specify the behavior information on a user.

Evaluation score may be changed appropriately. With respect to the evaluation method, not a score system that is previously specified, but relative positional relationship between nodes may be used. For example, the number of nodes between a node to be evaluated and the node influenced by the node or the length of the path may be used.

The first embodiment has been described by exemplifying a tree diagram from a problem to derivation of a solution. Alternatively, the same processing may be performed on a discussion where opinions are exchanged on a theme. In this case, the problem corresponds to the theme and the opinions correspond to the nodes and a conclusion or specific information corresponds to the solution. Furthermore, proposals and information have been described above as examples of node; alternatively, they may be changed appropriately according to the theme, etc. When information on a theme is the start point and specific information is the goal, sets of information associated on the downstream side or the upstream side that are, in number, equal to or larger than a predetermined number or are relatively large in number may be extracted or output. Information that is registered at first may be extracted or output after the interval between registration timings that is equal to or longer than a given time period or a relatively long interval. The information referred herein is, for example, the number of nodes, the types of node, the number of links, the types of link, the behavior information specified from the nodes and links, and the characters.

Number of Problems and Solutions

The first embodiment has been described by exemplifying the case where one solution to one problem is derived. Alternatively, for example, the creativity support server 10 may perform the same process when new multiple problems are proposed in a discussion on one problem. For example, with respect to each problem, the creativity support server 10 may refer back to the problem from the solution and calculate the total scores on nodes and turning points to calculate the degree of contribution of each user. The creativity support server 10 may calculate the total scores on nodes and turning points with respect to the first problem to calculate the degree of contribution of each user.

Collective Management of Input Information

The creativity support server 10 may store, with respect to each user, all nodes generated by the user and the time points at which the user generates the nodes, etc., in the storage unit 12, thereby collectively manage them. The collective management enables counting of the number of nodes generated by the user in a long time span, such as one year, and evaluation on the number of comments made by the user.

Between Groups

The first embodiment has been described by exemplifying the case where the creativity support server 10 transmits, for example, a message that activates a discussion; however, the users to which the message is transmitted are not limited to users in the same group. For example, when there is no character that breaks stagnation, or the like, the creativity support server 10 may search other groups for a corresponding user and induce the user to participate in the discussion.

Vital Data and Position Data

The first embodiment has been described by exemplifying the case where timestamps are assigned to nodes. Alternatively, for example, viral data or position information may be assigned. For example, the creativity support server 10 may acquire vital data, such as the blood pressure and the number of heart rates at the timings at which nodes are generated from a wearable device that a user wears and may manage the vital data in association with the nodes.

In this manner, the creativity support server 10 is able to specify in which state a lot of nodes are generated with respect to each user. As a result, the creativity support server 10 is able to notify the user of a state where nodes are generated, i.e., a condition enabling creation of a lot of ideas.

The creativity support server 10 may specify the feeling of the user from the vital data and associates the feeling with nodes. Even when it is not possible to acquire feeling data from the initial vital data, manual inputs may be used alternatively. For example, a user may make an input representing which feeling the user has. Accordingly, with respect to each user, the creativity support server 10 is able to specify and represent which type of node is generated and in which feeling the node is generated.

The creativity support server 10 may acquire position information from a global positioning system of, for example, a wearable device or a mobile phone that the user wears or holds and manage the nodes and position information in association with each other. Accordingly, the creativity support server 10 is able to specify and represent that a lot of nodes are generated on a train and during walking. Similarly, the creativity support server 10 is able to specify and represent which type of node is generated on a train or during walking.

As described above, the creativity support server 10 may associate information that can be acquired from an existing device and that is worn by the user with nodes to extract and represent information of which the user is not conscious. In other words, the creativity support server 10 may represent, as “recognition”, a new point of view that does not be recognized because the user is not conscious of the information.

Hardware

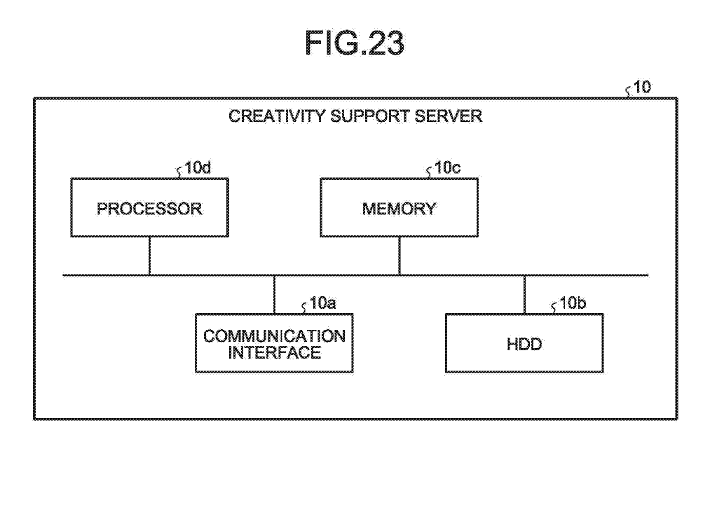

The creativity support server 10 may be realized by a computer having the following hardware configuration. FIG. 23 is a diagram illustrating an exemplary hardware configuration. As illustrated in FIG. 23, the creativity support server 10 includes a communication interface 10a, a hard disk drive (HDD) 10b, a memory 10c, and a processor 10d.

As an example of the communication interface 10a, there is a network interface card. The HDD 10b is a storage device that stores the various DBs represented in FIG. 3.

As an example of the processor 10d, there is a central processing unit (CPU), a digital signal processor (DSP), a field programmable gate array (FPGA), a programmable logic device (PLD), or the like. As an example of the memory 10c, there is a random access memory, such as a synchronous dynamic random access memory (SDRAM), a read only memory (ROM), or a flash memory.

The creativity support server 10 runs as an information processing device that executes a notifying method by reading and executing a program. In other words, the creativity support server 10 executes a program that implements the same functions equivalent to the structuring unit 21, the contribution degree determination unit 26, and the support unit 30. As a result, the creativity support server 10 is capable of executing the processes to implement the functions equivalent to the structuring unit 21, the contribution degree determination unit 26, and the support unit 30. Note that program referred in other embodiments is not limited to execution by the creativity support server 10. For example, the present invention may be similarly applied to, for example, a case where another computer or server executes the program or a case where they run together to execute the program.

The program may be distributed via a network, such as the Internet. The program may be recorded in a computer-readable recording medium, such as a hard disk, a flexible disk (FD), a CD-R, a magneto-optical disk (MO), or a digital versatile disc (DVD) and a computer may read the program from the recording medium and execute the program.

System

Each component of each device represented in FIG. 3 do not always need to be configured physically as illustrated. In other words, the components may be distributed or integrated in any unit. For example, the structuring unit 21 and the contribution degree determination unit 26 may be integrated. Furthermore, all or any part of the processing functions implemented in each device may be implemented by the CPU and the program that is analyzed and executed by the CPU or may be implemented in hardware employing the wired logic.

Among the processes according the embodiments described above, all or part of the processes described as ones that are automatically performed may be manually performed. Alternatively, all or part of the processes described as ones that are manually performed may be automatically performed with a known method. Furthermore, the process procedures, the control procedures, the specific names, the information including various types of data and parameters may be changed to any ones unless otherwise noted.

According to the embodiment, it is possible to provide sufficient creativity support.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
extracting a node that is generated by a user from a tree diagram that is generated according to nodes each representing an opinion created by each user to derive a solution to a problem dealt with in a discussion and links each representing relevance between the nodes;
classifying the extracted node according to dependency between the extracted node and other nodes included in the tree diagram; and
specifying a character of the user according to result of the classifying.

2. The non-transitory computer-readable recording medium according to claim 1, wherein
the extracting includes extracting each node generated by the user from each tree diagram corresponding to the problem to be dealt with in each discussion in which the user participates;
the classifying includes classifying the extracted nodes according to the each node the dependency in the tree diagram including the node; and
the specifying includes specifying the character of the user according to the result of classifying the each node and total number of nodes generated by the user.

3. The non-transitory computer-readable recording medium according to claim 2, wherein
the classifying includes classifying the each extracted node into any one of a plurality of node types that are predetermined according to the dependency with respect to other nodes included in the tree diagram and influence in which the node generated by the user gives for the solution, and
the specifying includes specifying the character of the user according to the node type into which nodes that are, in number, equal to or larger than a threshold are classified.

4. The non-transitory computer-readable recording medium according to claim 1, wherein the process further comprises:
estimating a factor that has not reached the solution by using the type of each node in the tree diagram that has not reached the solution; and
issuing a request for generating a node in the tree diagram to the user corresponding to the character that overcomes the factor.

5. The non-transitory computer-readable recording medium according to claim 1, wherein the process further comprises:
specifying a type of each node in the tree diagram that has not reached the solution, counting number of nodes corresponding to each type, and detecting the type that is equal to or smaller than a given number in the number of nodes; and
notifying each user who participates in the discussion corresponding to the tree diagram of fact that the detected type is in shortage.

6. The non-transitory computer-readable recording medium according to claim 1, wherein
the node is associated with a sensor value that is measured by a wearable device worn by the user who generates the node at the time when the node is generated, and
the process further comprises extracting a state in which the user generates the node by using the sensor value of each node generated by the user and notifying the user of the state.

7. The non-transitory computer-readable recording medium according to claim 1, wherein
the node is associated with information on a position at which the node is generated, and
the process further comprises extracting a behavior of the user to generate the nodes that are, in number, equal to or larger than a predetermined number and notifying the user of the behavior.

8. A specifying method comprising:
extracting a node that is generated by a user from a tree diagram that is generated according to nodes each representing an opinion created by each user to derive a solution to a problem dealt with in a discussion and links each representing relevance between the nodes, by a processor;
classifying the extracted node according to dependency between the extracted node and other nodes included in the tree diagram, by the processor; and
specifying a character of the user according to result of the classifying, by the processor.

9. A specifying apparatus comprising:
a memory; and
a processor that is connected to the memory, wherein the processor executes a process including:
extracting a node that is generated by a user from a tree diagram that is generated according to nodes each representing an opinion created by each user to derive a solution to a problem dealt with in a discussion and links each representing relevance between the nodes;
classifying the extracted node according to dependency between the extracted node and other nodes included in the tree diagram; and
specifying a character of the user according to result of the classifying.

10. A method of analyzing provided information, the method comprising:
accepting registration of information associated with a theme and registration of information associated with the registered information, using a processor;
accepting specification of specific information among the registered information, using the processor; and
extracting information included in a path leading to the specific information from the information associated with the theme or a path leading to the theme from the information associated with the specific information, using the processor.

11. The method of analyzing provided information according to claim 10, further comprising
accepting registration of information representing classification of information to be registered, using the processor,
wherein the extracting includes extracting the information in which information representing a specific classification is registered.

12. The method of analyzing provided information according to claim 10, further comprising
accepting registration of information representing a registration timing at which the information is registered is registered, using the processor,
wherein the extracting includes extracting the information that is registered at first after an interval between registration timings that is equal to or longer than a predetermined time period or a relatively long interval.

13. The method of analyzing provided information according to claim 10, wherein the extracting includes extracting sets of information that are, in number, equal to or larger than a predetermined number or are relatively large in number.

14. The method of analyzing provided information according to claim 10, wherein the extracting includes extracting, when information on the theme is a start point and the specific information is a goal, sets of information associated on a downstream side that are, in number, equal to or larger than a predetermined number or are relatively large in number are extracted.

15. The method of analyzing provided information according to claim 10, wherein the extracting includes extracting, when information on the theme is a start point and the specific information is a goal, sets of information associated on an upstream side that are, in number, equal to or larger than a predetermined number or are relatively large in number are extracted.

16. The method of analyzing provided information according to claim 10, further comprising outputting information on a user who registers the extracted information.

17. A method of analyzing provided information, the method comprising:
accepting registration of information associated with a theme and registration of information associated with the registered information, using a processor;
accepting specification of specific information among the registered information, using the processor; and
outputting information on a user who registers sets of registered information included in a path leading to the specific information from the information associated with the theme or a path leading to the theme from the information associated with the specific information, which are sets of registered information that are, in number, equal to or larger than a predetermined number or are relatively large in number, using the processor.

18. A method of analyzing provided information, the method comprising:
accepting an input of evaluation on information that is registered, using a processor; and
extracting, from among information included in a path leading to specific information from information associated with the theme or a path leading to the theme from information associated with the specific information, information for which a relatively high evaluation is input, using the processor.
